(19) United States
(12) Patent Application Publication
(10) Pub. No.: US 2008/0034817 A1
(43) Pub. Date: Feb. 14, 2008

(54) LOCK MODULE

(75) Inventor: Chia-Huang Chan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/768,186

(22) Filed: Jun. 25, 2007

(30) Foreign Application Priority Data
Aug. 9, 2006 (TW) 95129192

(51) Int. Cl. E05B 69/00

(52) U.S. Cl. 70/58

(57) ABSTRACT

A lock module suitable for being locked to a lock shaft of a portable electronic device is provided. The lock module includes a first lock element and a second lock element. The first lock element includes a first body and a first fastener extending from the first body, and the second lock element includes a second body coupled with the first body and a second fastener extending from the second body. The second fastener and the first fastener are inserted into each other. A limiting space is formed between the first fastener and the second fastener, and the lock shaft is limited in the limiting space.

### CROSS-REFERENCE TO RELATED APPLICATION

This application claims the priority benefit of Taiwan application serial no. 95129192, filed Aug. 9, 2006. All disclosure of the Taiwan application is incorporated herein by reference.

### BACKGROUND OF THE INVENTION

1. Field of the Invention

The present invention relates to a lock module. More particularly, the present invention relates to a lock module suitable for portable electronic devices.

2. Description of Related Art

Along with the development of science and technology, portable electronic devices have become more and more popular in recent years. The portable electronic devices are, for example, notebooks, mobile phones or personal digital assistants (PDAs). Basically, the portable electronic devices are advantageous because they are easy to carry. However, as these portable electronic devices are easy to carry, it is possible that the portable electronic devices are improperly moved or stolen if the users do not pay enough attention on them.

FIG. 1A is a schematic view of a Kensington lock and a portable electronic device, and FIG. 1B is a schematic view that a portable electronic device is locked to a Kensington lock. As shown in FIGS. 1A and 1B, a plurality of input/output (IO) ports 14 are disposed in a body 12 of a portable electronic device 10 to expand peripheral functions of the portable electronic device 10. Moreover, a lock hole 16 is disposed in the body 12, such that the Kensington lock 100 is inserted into the lock hole 16. Generally, one end of the Kensington lock 100 locks the lock hole 16, and the other end of the Kensington lock 100 is fixed to a fixed object, such as a table. Thus, the user can prevent the portable electronic device 10 from being improperly moved or stolen through the locking between the lock hole 16 and the Kensington lock 100.

It should be noted that when the Kensington lock 100 is locked to the portable electronic device 10, if the user needs to assemble an external connector 18 to the I/O port 14, as the position of the Kensington lock 100 is on the assembling path L1 of the connector 18 to the I/O port 14, the connector 18 will be interfered by the Kensington lock 100, and cannot be smoothly assembled to the I/O port 14 (see FIG. 1C, a schematic view showing while the external connector 18 moves along the assembling path L1 is shown).

Furthermore, as the portable electronic devices available on the market are designed to be light and thin, Kensington locks or other large-scale lock elements cannot be locked to the light and thin portable electronic devices directly. For example, it is difficult for Kensington locks to be locked to portable electronic devices such as smart phones or PDAs.

Therefore, an objective of the present invention is to improve the position where a Kensington lock is arranged, so as to prevent the interference of the Kensington lock when a connector is assembled to I/O port. In addition, the present invention also provides a preferred lock module, which provides antitheft function to light and thin portable electronic devices available in the market.

### SUMMARY OF THE INVENTION

An objective of the present invention is to provide a lock module such that an external connector may be smoothly jointed to the I/O port of a portable electronic device due to the arrangement of a Kensington lock.

Another objective of the present invention is to provide a lock module suitable for being locked to a light and thin portable electronic device directly.

In accordance with the aforementioned or other objectives, the present invention provides a lock module suitable for being locked to a lock shaft disposed on a portable electronic device. The lock module comprises a first lock element and a second lock element. The first lock element comprises a first body and a first fastener extending from the first body, and the second lock element comprises a second body coupled with the first body and a second fastener extending from the second body. The second fastener and the first fastener are inserted into each other. A limiting space is formed between the first fastener and the second fastener, and the lock shaft is limited in the limiting space.

In one embodiment of the present invention, the first fastener has two corresponding first fastening hooks, and a first fastening groove is formed between the first fastening hooks. The second fastener has two corresponding second fastening hooks, and a second fastening groove is formed between the second fastening hooks. One of the first fastening hooks is inserted into the second fastening groove, and one of the second fastening hooks is inserted into the first fastening groove.

In one embodiment of the present invention, the lock module further comprises a third lock element. The first body has a first lock hole, the second body has a second lock hole corresponding to the first lock hole, and the third lock element passes through the first lock hole and the second lock hole.

In one embodiment of the present invention, the third lock element is a Kensington lock.

In one embodiment of the present invention, the first lock element further comprises a first buckling portion extending from the first body, the second body comprises a second buckling groove corresponding to the first buckling portion, and the first buckling portion is buckled in the second buckling groove.

In one embodiment of the present invention, the second lock element further comprises a second buckling portion extending from the second body, the first body comprises a first buckling groove corresponding to the second buckling portion, and the second buckling portion is buckled in the first buckling groove.

In one embodiment of the present invention, the first body comprises a first jointing portion, the second body comprises a second jointing portion, and the first jointing portion is coupled with the second jointing portion.

In one embodiment of the present invention, the first body further comprises a third jointing portion, the second body further comprises a fourth jointing portion, and the fourth jointing portion is coupled with the third jointing portion.

In one embodiment of the present invention, the first body further comprises a fifth jointing portion, the second body further comprises a sixth jointing portion, and the fifth jointing portion is coupled with the sixth jointing portion.

In the lock module of the present invention, the first body of the first lock element is coupled with the second body of the second lock element, the first fastener extending from the first body and the second fastener extending from the second body are inserted into each other, the lock shaft on the portable electronic device is limited in the limiting space formed with the first fastener and the second fastener, and the Kensington lock provides antitheft function to the portable electronic device through the combination of the first lock element and the second lock element. The Kensington lock combined with the first lock element and the second lock element is not located on the assembling path of the connector to the I/O port. In other words, the external connector can be smoothly assembled to the I/O port of the portable electronic device. Moreover, the lock module of the present invention can be directly locked to a light and thin portable electronic device to prevent the portable electronic device from being improperly moved or stolen.

In order to make the aforementioned and other objects, features and advantages of the present invention comprehensible, preferred embodiments accompanied with figures are described in detail below.

### BRIEF DESCRIPTION OF THE DRAWINGS

FIG. 1A is a schematic view of a Kensington lock and a portable electronic device.

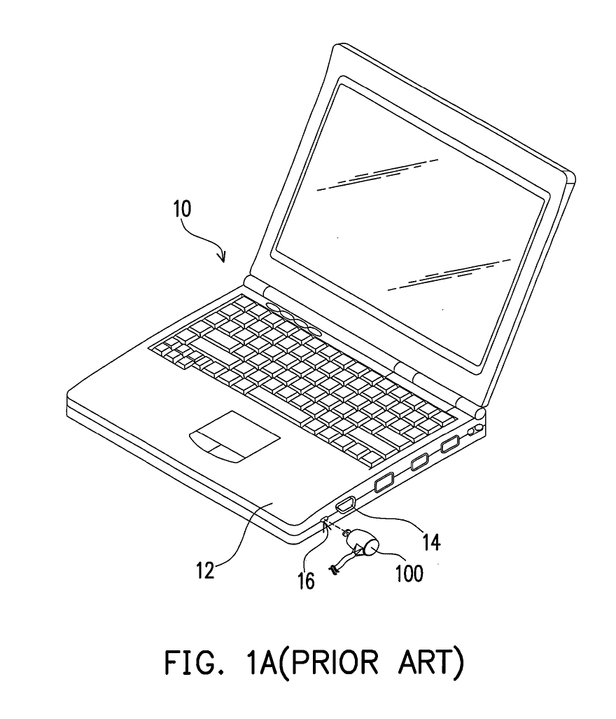

FIG. 1B is a schematic view showing a Kensington lock being locked to a portable electronic device.

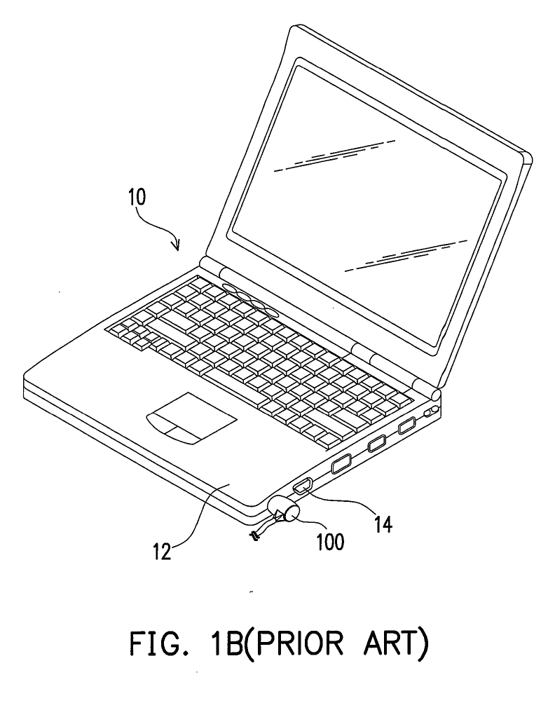

FIG. 1C is a schematic view showing while an external connector moves along an assembling path.

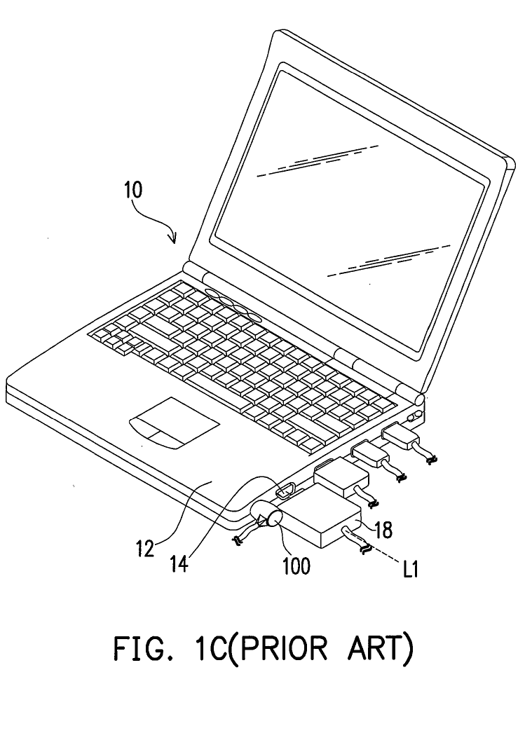

FIG. 2A is an exploded view of a lock module and a portable electronic device according to a preferred embodiment of the present invention.

FIG. 2B is a schematic view showing the lock module of FIG. 2A being locked to a portable electronic device.

FIG. 3A is an enlarged view of the first lock element and the second lock element of FIG. 2A when viewed from another angle.

FIG. 3B is an exploded view of the first lock element and the second lock element of FIG. 3A.

### DESCRIPTION OF EMBODIMENTS

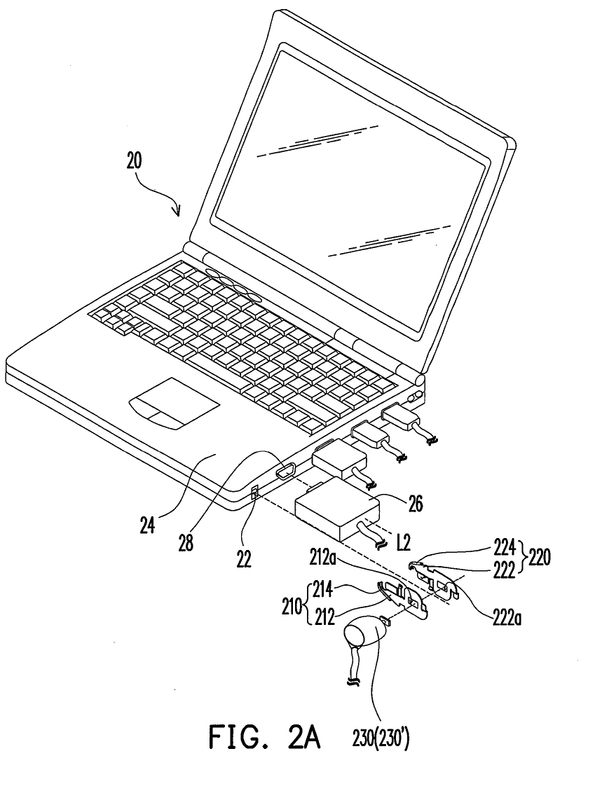

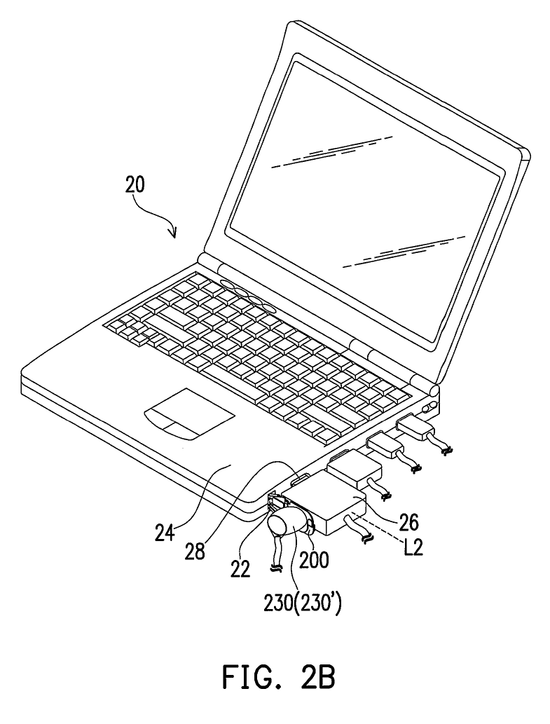

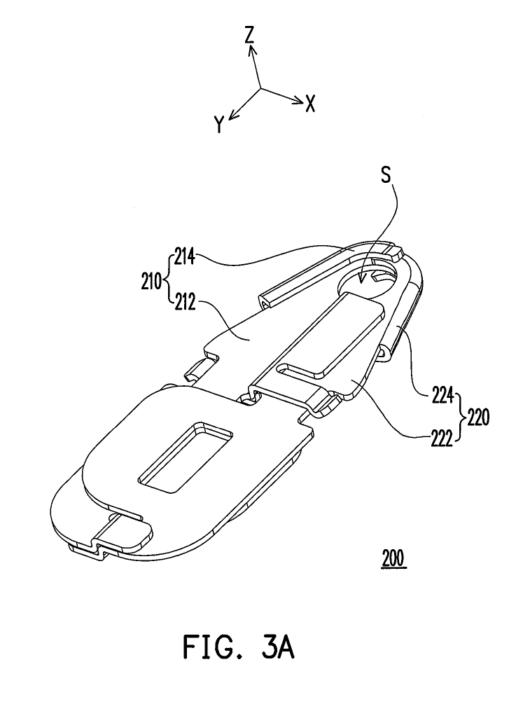

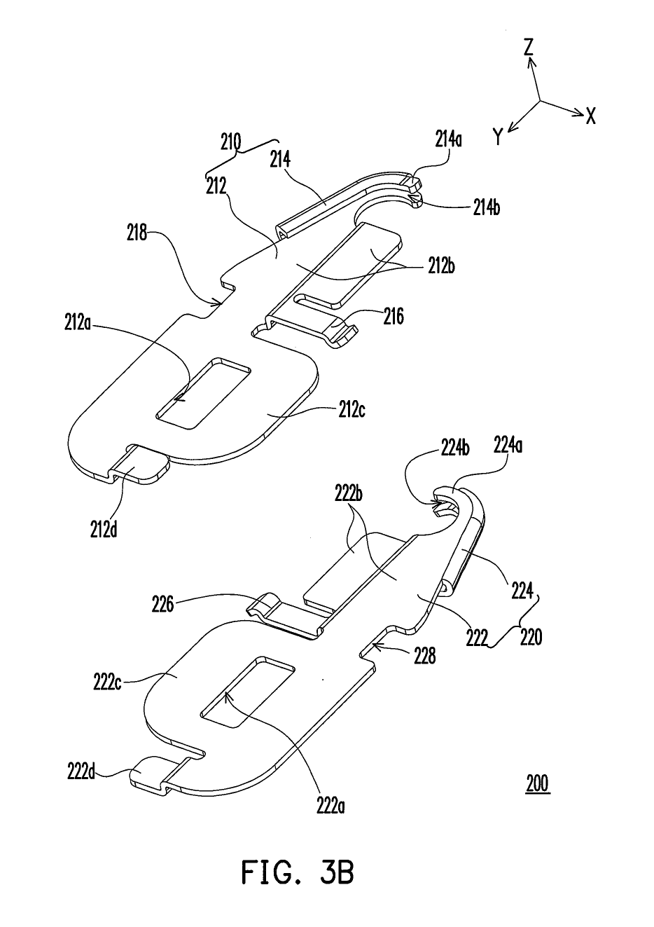

FIG. 2A is an exploded view of a lock module and a portable electronic device according to a preferred embodiment of the present invention, FIG. 2B is a schematic view showing the lock module of FIG. 2A being locked to the portable electronic device, and FIG. 3A is an enlarged view of the first lock element and the second lock element of FIG. 2A when viewed from another angle. Referring to FIGS. 2A, 2B and 3A for the description to the preferred embodiment of the present invention, the lock module 200 in this embodiment is locked to a lock shaft 22 of a portable electronic device 20. In this embodiment, the lock module 200 includes a first lock element 210 and a second lock element 220. The first lock element 210 and the second lock element 220 are, for example, two corresponding locking plates. The first lock element 210 includes a first body 212 and a first fastener 214 extending from the first body 212, and the second lock element 220 includes a second body 222 coupled with the first body 212 and a second fastener 224 extending from the second body 222. The second fastener 224 and the first fastener 214 are inserted into each other. A limiting space S is formed between the first fastener 214 and the second fastener 224, and the lock shaft 22 of the portable electronic device 20 is limited in the limiting space S.

Accordingly, the first lock element 210 and the second lock element 220 are used to limit the lock shaft 22 in the limiting space S. In this embodiment, a third lock element 230 can be used to connect to the first lock element 210 and the second lock element 220 inserted into each other. The third lock element 230 is, for example, a Kensington lock 230′, and the portable electronic device 20 can be limited in a specific area with the Kensington lock 230′. Thus, the portable electronic device 20 may not be improperly moved or stolen. For example, the first body 212 has a first lock hole 212a, the second body 222 has a second lock hole 222a corresponding to the first lock hole 212a, and the Kensington lock 230′ passes through the first lock hole 212a and the second lock hole 222a. Particularly, the Kensington lock 230′ provides antitheft function to the portable electronic device 20 through the connection to the first lock element 210 and the second lock element 220.

It should be noted that in this embodiment, the Kensington lock 230′ is not directly locked to the body 24 of the portable electronic device 20 (the Kensington lock 230′ provides antitheft function to the portable electronic device 20 through the combination of the first lock element 210 and the second lock element 220). In other words, the Kensington lock 230′ is not located on an assembling path L2 of a connector 26 to an I/O port 28. Therefore, when a user needs to assemble the external connector 26 to the I/O port 28 in the body 24, the connector 26 may be smoothly assembled to the 20 I/O port 28 without being interfered by the Kensington lock 230′.

According to another aspect of the present invention, the lock module 200 of the present invention is also applicable to various light and thin portable electronic devices. For example, current mobile phones generally have lock shafts on them for hanging pendants. The user can use the combination of the first lock element 210 and the second lock element 220 to limit the lock shaft of a mobile phone in the limiting space S, and combine the third lock element 230 with the first lock element 210 and the second lock element 220, so as to prevent the mobile phone in exhibition from being improperly moved or stolen. In other embodiments, the portable electronic devices can be palmtops, tablet PCs, UMPCs, smartphones, or GPS devices.

The jointing of the first lock element 210 and the second lock element 220 will be described in detail below. FIG. 3B is an exploded view of the first lock element and the second lock element of FIG. 3A. Referring to FIGS. 3A and 3B together, in this embodiment, the first body 212 of the first lock element 210 is coupled with the second body 222 of the second lock element 220, and the second fastener 224 of the second lock element 220 and the first fastener 214 of the first lock element 210 are inserted into each other.

Here, the jointing between the first body 212 and the second body 222 will be described first. In this embodiment, the first lock element 210 can include a first buckling portion 216 extending from the first body 212, and the second body 222 includes a second buckling groove 228 corresponding to the first buckling portion 216. Similarly, the second lock element 220 can include a second buckling portion 226 extending from the second body 222, and the first body 212 includes a first buckling groove 218 corresponding to the second buckling portion 226.

The first buckling portion 216 is buckled to the second buckling groove 228, and the second buckling portion 226 is buckled to the first buckling groove 218. For example, the first buckling groove 218 is a concave structure on a side edge of the first body 212, and the second buckling groove 228 is a concave structure on a side edge of the second body 222. The first buckling portion 216 is buckled to the concave structure (the second buckling groove 228) on the side edge of the second body 222, and the second buckling portion 226 is buckled to the concave structure (the first buckling groove 218) on the side edge of the first body 212.

As the first buckling portion 216 and the second buckling portion 226 are respectively buckled to the concave structures on the side edges of the second body 222 and the first body 212, it is difficult for the first lock element 210 and the second lock element 220 to have relative displacement in the X direction and the Y direction (the relative displacement of the first lock element 210 and the second lock element 220 in the X direction is limited by the first buckling portion 216 and the second buckling portion 226, and the relative displacement of the first lock element 210 and the second lock element 220 in the Y direction is limited by the interference between the buckling portions and the buckling grooves). In other words, the first lock element 210 and the second lock element 220 are well jointed.

Moreover, in a preferred embodiment, the first body 212 has a first jointing portion 212b, a third jointing portion 212c and a fifth jointing portion 212d, and the second body 222 has a second jointing portion 222b corresponding to the first jointing portion 212b, a fourth jointing portion 222c corresponding to the third jointing portion 212c, and a sixth jointing portion 222d corresponding to the fifth jointing portion 212d.

The first jointing portion 212b is coupled with the second jointing portion 222b. The third jointing portion 212c surrounds the first lock hole 212a, the fourth jointing portion 222c surrounds the second lock hole 222a, and the fourth jointing portion 222c can be coupled with the third jointing portion 212c. The fifth jointing portion 212d is formed by extending from the third jointing portion 212c, the sixth jointing portion 222d is formed by extending from the fourth jointing portion 222c, and the fifth jointing portion 212d can be coupled with the sixth jointing portion 222d. Through the connections described above, the first lock element 210 and the second lock element 220 can be well combined, that is, the first lock element 210 and the second lock element 220 will not easily get separated when being exerted with an improper external force.

For example, when the first lock element 210 and second lock element 220 inserted into each other are pulled with two external forces in two opposite directions along the Z axis, the plurality of jointing portions on the first body 212 and the plurality of jointing portions on the second body 222 mutually limit their positions (the first jointing portion 212b and the second jointing portion 222b mutually limit their positions, the third jointing portion 212c and the fourth jointing portion 222c mutually limit their positions, and the fifth jointing portion 212d and the sixth jointing portion 222d mutually limit their positions), thus, the first body 212 cannot be separated from the second body 222. In other words, the first body 212 and the second body 222 can be jointed firmly. In addition, when a twisting force around the Y direction is applied on the lock module 200, the plurality of jointing portions on the first body 212 and the plurality of jointing portions on the second body 222 mutually limit their positions as well. The limiting relationship of the jointing portions allows the first lock element 210 and the second lock element 220 to be inserted into each other firmly after the twisting force is applied. Particularly, in this embodiment, the first lock element 210 and second lock element 220 inserted into each other are well jointed in the X, Y, and Z directions.

The inserting mode of the second fastener 224 and the first fastener 214 will be described in detail below. Referring to FIG. 3B for relevant descriptions, in this embodiment, for example, the first fastener 214 has two corresponding first fastening hooks 214a, and a first fastening groove 214b is formed between the first fastening hooks 214a. Similarly, for example, the second fastener 224 has two corresponding second fastening hooks 224a, and a second fastening groove 224b is formed between the second fastening hooks 224a.

In addition, one of the first fastening hooks 214a is inserted into the second fastening groove 224b, and one of the second fastening hooks 224a is inserted into the first fastening groove 214b. In other words, the first fastener 214 and the second fastener 224 are inserted into each other, and the limiting space S is formed between the first fastener 214 and the second fastener 224. Here, the number of the fastening hooks of the first fastener 214 or the second fastener 224 is not limited in the present invention. For example, the second fastener 224 can have a second fastening hook 224a, and the second fastening hook 224a is inserted into the first fastening groove 214b. Thus, the limiting space S can also be formed between the first fastener 214 and the second fastener 224. It should be noted that as the second fastening hook 224a is inserted into the first fastening groove 214b (or the first fastening hook 214a is inserted into the second fastening groove 224b), the first fastener 212 and the second fastener 222 can be well inserted into each other (the jointing between the first fastener 212 and the second fastener 222 will not be destroyed).

To sum up, in the lock module according to the preferred embodiment of the present invention, the first body of the first lock element is coupled with the second body of the second lock element, the first fastener extending from the first body and the second fastener of the second body are inserted into each other, and the lock shaft of the portable electronic device can be limited in the limiting space through the inserting of the first fastener and the second fastener with each other. The present invention has at least the following advantages.

(1) The lock module according to the preferred embodiment of the present invention can lock the lock shaft on the portable electronic device through the jointing of the first lock element and the second lock element, and the Kensington lock (the third lock element) provides the antitheft function to the portable electronic device through the combination of the first lock element and the second lock element. Thus, the Kensington lock will not block the assembling path of the connector to the I/O port. In other words, the connector can be assembled to the I/O port of the portable electronic device smoothly.

(2) In the lock module according to the preferred embodiment of the present invention, the limiting space formed with the first lock element and the second lock element is used to limit the lock shaft on the portable electronic device, thus the lock module of the present invention can lock a light and thin portable electronic device directly to provide antitheft function to the portable electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lock module, suitable for locking to a lock shaft disposed on a portable electronic device, the lock module comprising:
a first lock element, comprising:
a first body;
a first fastener extending from the first body;
a second lock element, comprising:
a second body for coupling with the first body; and
a second fastener, extending from the second body, and inserted into the first fastener, wherein a limiting space is formed between the first fastener and the second fastener, and the lock shaft is limited in the limiting space.

2. The lock module as claimed in claim 1, wherein the first fastener has two corresponding fastening hooks, and a first fastening groove is formed between the first fastening hooks; the second fastener has two corresponding fastening hooks, and a second fastening groove is formed between the second fastening hooks; one of the first fastening hooks is inserted into the second fastening groove, and one of the second fastening hooks is inserted into the first fastening groove.

3. The lock module as claimed in claim 1, further comprising a third lock element, wherein the first body has a first lock hole, the second body has a second lock hole corresponding to the first lock hole, and the third lock element passes through the first lock hole and the second lock hole.

4. The lock module as claimed in claim 3, wherein the third lock element is a Kensington lock.

5. The lock module as claimed in claim 1, wherein the first lock element further comprises a first buckling portion extending from the first body, the second body comprises a second buckling groove corresponding to the first buckling portion, and the first buckling portion is buckled in the second buckling groove.

6. The lock module as claimed in claim 1, wherein the second lock element further comprises a second buckling portion extending from the second body, the first body comprises a first buckling groove corresponding to the second buckling portion, and the second buckling portion is buckled in the first buckling groove.

7. The lock module as claimed in claim 1, wherein the first body comprises a first jointing portion, the second body comprises a second jointing portion, and the first jointing portion is coupled with the second jointing portion.

8. The lock module as claimed in claim 7, wherein the first body further comprises a third jointing portion, the second body further comprises a fourth jointing portion, and the fourth jointing portion is coupled with the third jointing portion.

9. The lock module as claimed in claim 8, wherein the first body further comprises a fifth jointing portion, the second body further comprises a sixth jointing portion, and the fifth jointing portion is coupled with the sixth jointing portion.
